(19) United States
(12) Patent Application Publication
(10) Pub. No.: US 2012/0143754 A1
(43) Pub. Date: Jun. 7, 2012

(54) ENHANCED CREDIT CARD SECURITY APPARATUS AND METHOD

(76) Inventor: Narendra Patel, San Antonio, TX (US)

(21) Appl. No.: 13/311,262

(22) Filed: Dec. 5, 2011

Related U.S. Application Data
(60) Provisional application No. 61/419,480, filed on Dec. 3, 2010.

(51) Int. Cl. G06Q 20/34; G06Q 20/40

(52) U.S. Cl. 705/41

(57) ABSTRACT

A credit card, debit card, or other similar financial instrument is disclosed with the temporary assignment of a dynamic CVV for increased card security. The dynamic CVV is read, changed, and rewritten to the card with each transaction. To facilitate online purchases, a static CVV may also be provided for manual entry. Alternatively, the static CVV may be a reminder enabling a user to remember an unmarked static CVV, such as reading the digits in an order selected by a user, much like a PIN number.

### RELATED APPLICATIONS

This application claims the benefit of co-pending U.S. Provisional Patent Application Ser. No. 61/419,480, filed on Dec. 3, 2010 for ENHANCED CREDIT CARD SECURITY.

### BACKGROUND

1. The Field of the Invention

This invention relates to financial transactions and, more particularly, to novel systems and methods for security codes for transactional cards, such as credit cards, ATM cards, gift cards, debit cards, and the like.

2. The Background Art

It is increasingly common for people to transact business using transactional cards or financial cards, such as credit cards, ATM cards, gift cards, debit cards, other cards and the like, rather than cash or checks. Any reference to one of these forms is intended to refer to any and all types herein. One common security measure used to prevent fraud in such transactions is the use of a card verification value (CVV) or similar code to ensure that the person using a card is the card holder. A CVV may also be referred to as a card security code, card verification data, card verification value code, verification code, card code verification, or similar term. The use of the term “CVV” throughout this specification is intended to encompass all of the foregoing.

In credit transactions or other transactions in which payment is made by a credit card, a static CVV may assigned to the card and printed on the card. When a user completes a transaction, an exemplary method of verifying the card or account may include receiving the card number, expiration date, and CVV. In particular, a CVV may be required when a user makes an online purchase or is otherwise required to manually input card data. Additional identifying data may also be required in certain credit transactions and other financial transactions to verify the user's identity. For example, the user may be required to provide a name, address, zip code, personalized security information, response to a personal security question, password, or a combination thereof.

### BRIEF SUMMARY OF THE INVENTION

In one aspect, a credit card, debit card, charge card, or other similar financial instrument is disclosed with the assignment of a dynamic CVV for increased card security. The dynamic CVV is rewritten to the card with each transaction. To facilitate online purchases, a static CVV may also be provided for manual entry. Hereinafter, any reference to a card or financial instrument includes transactional cards, electronic transaction cards, monetary cards, or generally financial cards, such as credit cards, ATM cards, gift cards, debit cards, and like financial instruments.

In one embodiment, a networked system of computers between a card issuer an merchants, or a plurality of both may operate to communicate dynamically security information that can actually be changed on a financial card in user.

In one embodiment of a method of verification, the method may include providing a financial card comprising a computer readable storage medium embedded in it. Then, providing a dynamic portion of the computer readable storage medium as a computer writable medium, may enable designating the dynamic portion as the storage location of a dynamic code to be selectively read from and written to the computer readable storage medium.

In use, receiving, by an issuer computer corresponding to an issuer of the financial card, transaction information from a first transaction in which the information from the financial card is presented as a form of payment may be followed by receiving, by the issuer computer, a first value of the dynamic code stored in the dynamic portion. Thereby verifying, by the issuer computer, the authenticity of the first transaction based at least in part on the receiving the first value, the codes are obsolete.

Therefore, such use and verification is followed by deleting, by the issuer computer, the first value after the verifying. The issuer computer then writes or causes an intermediate transaction device to write a second value of the dynamic code to the dynamic portion.

In some embodiments, the method includes the financial card being selected from a credit card, a debit card, a gift card, and a purchase order. Likewise, the method contemplates receiving, by the issuer computer, data representing presentation of the financial card to a second merchant in a second transaction subsequent to the first transaction. Thereafter, the computer can verify and authorize completion of the second transaction.

The method may involve receiving, by the financial card, during a second transaction, a third value for the dynamic code replacing the second value. The method may include the first transaction being completed by the financial card with a first merchant and a second transaction completed by the financial card with a second merchant.

Typically, the financial institution is independent from the first and second merchants, and the computer readable storage medium is non-volatile memory selected from magnetic media, optical media, flash media, and another solid state medium.

Some embodiments of a system and method may include receiving by the issuer computer, values of the dynamic code from a plurality of transactions corresponding to an authorized user of the financial card. Changing, by the issuer computer, the values of the dynamic code in accordance with a security scheme expiring the values based on instructions from the issuer computer may be followed by receiving an expired value of the dynamic code, representing a an unauthorized transaction by an unauthorized user. Thus the system fails any request for verification of the unauthorized transaction, based on the expired value.

One method may include providing a credit transaction system comprising the financial card, a transaction device in or connected to a computer. A first computer associated with a financial institution operating as an issuer of the financial card may be programmed to verify the authenticity of transactions based on the transaction device reading the dynamic code and reporting to the first computer based on the dynamic code.

It may be further programmed to send to the transaction device values to assign to the dynamic code, where the transaction device is configured to read and write to the financial card the dynamic code.

The credit transaction system may include a second computer corresponding to a merchant and operably connected to communicate with the first computer. With the second computer programmed to read from the financial card and provide to the second computer a first value corresponding to the dynamic code, the first value may be read by the second computer from the financial card during a transaction. The second computer may be further programmed to receive from the first computer a second value corresponding to the dynamic code. Meanwhile, the second computer may be programmed to overwrite the first value on the financial card with the second value during the transaction.

A user may select a financial card comprising a computer readable storage medium embedded therein, wherein a dynamic portion of the computer readable storage medium is also a computer writable medium. The dynamic portion is the storage location of a dynamic code to be selectively read from and written to the computer readable storage medium.

In use, the card is presented to a merchant computer in communication with an issuer computer, the merchant computer corresponding to a merchant in a transaction with the financial card and the issuer computer corresponding to an issuer of the financial card, first transaction information corresponding to a first transaction in which the information from the financial card is presented as a form of payment. Delivering, by the financial card to the issuer computer, a first dynamic code from the dynamic portion is followed by receiving verification from the issuer computer of the authenticity of the first transaction, based at least in part on the delivering the first dynamic code. The financial card then receives, from the issuer computer, a second dynamic code replacing the first dynamic code from the dynamic portion.

A credit transaction system may also include a second computer corresponding to a merchant and operably connected to communicate with a first computer. The second computer may be programmed to read from the financial card and provide to the second computer a first value corresponding to the dynamic code. The first value is read by the second computer from the financial card during a transaction, or read by a transaction device and passed on to the second computer.

The second computer may be programmed to receive from the first computer a second value corresponding to the dynamic code and overwrite the first value on the financial card with the second value during the transaction.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is schematic block diagram of a networked computer system for implementing the invention;

FIG. 2 is a network-level diagram of a network for use of an enhanced-security credit card;

FIG. 3 is a front and rear view of a credit card;

FIG. 4 is a block diagram of an exemplary data structure on a credit card; and

FIG. 5 is a block diagram of an exemplary transaction device.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

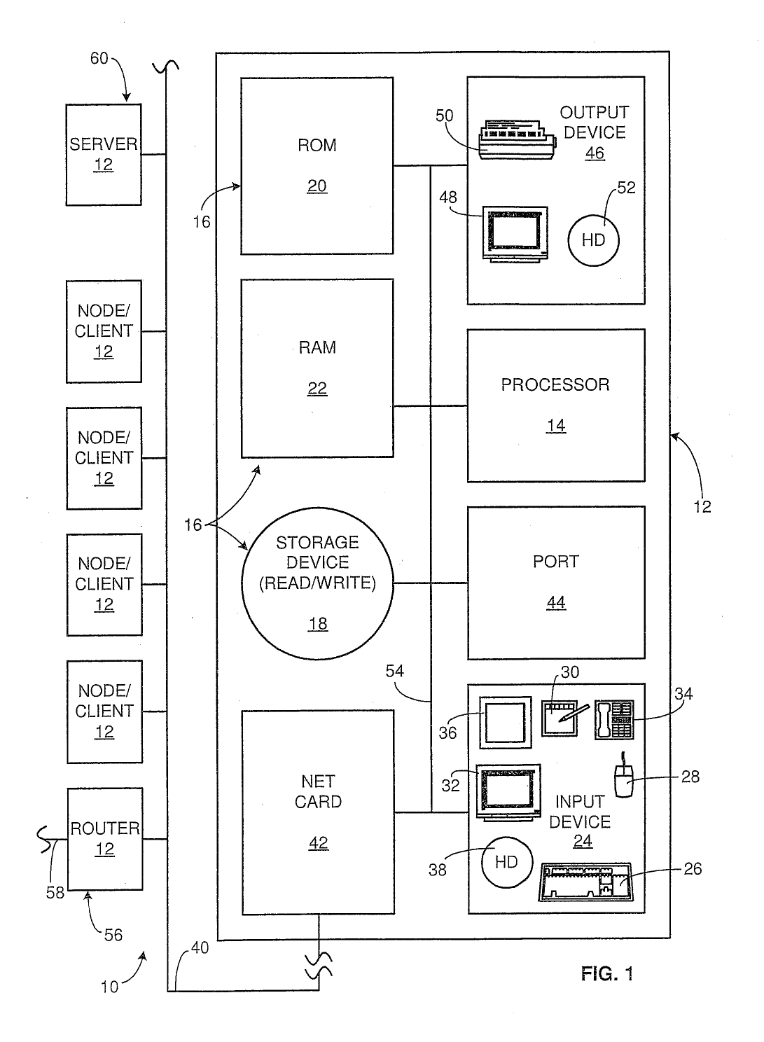

Referring to FIG. 1, an apparatus 10 or system 10 for implementing the present invention may include one or more nodes 12 (e.g., client 12, computer 12). Such nodes 12 may contain a processor 14 or CPU 14. The CPU 14 may be operably connected to a memory device 16. A memory device 16 may include one or more devices such as a hard drive 18 or other non-volatile storage device 18, a read-only memory 20 (ROM 20), and a random access (and usually volatile) memory 22 (RAM 22 or operational memory 22). Such components 14, 16, 18, 20, 22 may exist in a single node 12 or may exist in multiple nodes 12 remote from one another.

In selected embodiments, the apparatus 10 may include an input device 24 for receiving inputs from a user or from another device. Input devices 24 may include one or more physical embodiments. For example, a keyboard 26 may be used for interaction with the user, as may a mouse 28 or stylus pad 30. A touch screen 32, a telephone 34, or simply a telecommunications line 34, may be used for communication with other devices, with a user, or the like. Similarly, a scanner 36 may be used to receive graphical inputs, which may or may not be translated to other formats. A hard drive 38 or other memory device 38 may be used as an input device whether resident within the particular node 12 or some other node 12 connected by a network 40. In selected embodiments, a network card 42 (interface card) or port 44 may be provided within a node 12 to facilitate communication through such a network 40.

In certain embodiments, an output device 46 may be provided within a node 12, or accessible within the apparatus 10. Output devices 46 may include one or more physical hardware units. For example, in general, a port 44 may be used to accept inputs into and send outputs from the node 12. Nevertheless, a monitor 48 may provide outputs to a user for feedback during a process, or for assisting two-way communication between the processor 14 and a user. A printer 50, a hard drive 52, or other device may be used for outputting information as output devices 46.

Internally, a bus 54, or plurality of buses 54, may operably interconnect the processor 14, memory devices 16, input devices 24, output devices 46, network card 42, and port 44. The bus 54 may be thought of as a data carrier. As such, the bus 54 may be embodied in numerous configurations. Wire, fiber optic line, wireless electromagnetic communications by visible light, infrared, and radio frequencies may likewise be implemented as appropriate for the bus 54 and the network 40.

In general, a network 40 to which a node 12 connects may, in turn, be connected through a router 56 to another network 58. In general, nodes 12 may be on the same network 40, adjoining networks (i.e., network 40 and neighboring network 58), or may be separated by multiple routers 56 and multiple networks as individual nodes 12 on an internetwork. The individual nodes 12 may have various communication capabilities. In certain embodiments, a minimum of logical capability may be available in any node 12. For example, each node 12 may contain a processor 14 with more or less of the other components described hereinabove.

A network 40 may include one or more servers 60. Servers 60 may be used to manage, store, communicate, transfer, access, update, and the like, any practical number of files, databases, or the like for other nodes 12 on a network 40. Typically, a server 60 may be accessed by all nodes 12 on a network 40. Nevertheless, other special functions, including communications, applications, directory services, and the like, may be implemented by an individual server 60 or multiple servers 60.

In general, a node 12 may need to communicate over a network 40 with a server 60, a router 56, or other nodes 12. Similarly, a node 12 may need to communicate over another neighboring network 58 in an internetwork connection with some remote node 12. Likewise, individual components may need to communicate data with one another. A communication link may exist, in general, between any pair of devices.

Referring to FIGS. 1-5, an apparatus 10 or system 10 of FIG. 1, may embody multiple computers 12, each with its own processors 14 and memory devices 16. These may be networked together to host software implementing some, any, or all of the functions, relationships, and events discussed hereinbelow. Thus, each computer 12 may include any or all of the foregoing components and connections in order to implement the communications, data transfers, transactions, and the like as described.

Referring to FIGS. 1-5, a credit card 120 with dynamic CVV 330 for enhanced card security will now be described with more particular reference to the attached drawings. Details are set forth by way of example to facilitate discussion of the disclosed subject matter and render apparent the structures and functions to a person of ordinary skill in the art, however, that the disclosed embodiments are exemplary and not exhaustive of all possible embodiments.

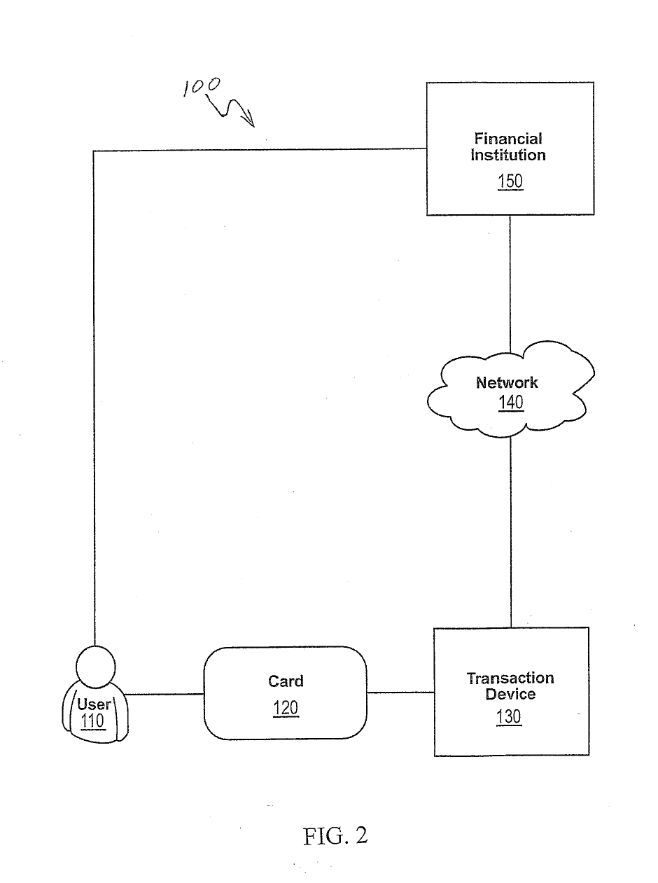

FIG. 2 illustrates an exemplary embodiment of a finance network. In the exemplary embodiment, the financial instrument is a credit card 120, but could also be a debit card 120, RFID device 120, or other similar identification instruments configured to allow a user 110 to access funds, with the important criterion that it has a storage medium 220, such as a portion of its magnetic strip 220 that is both readable and writable so that a dynamic CVV can be stored thereon.

Within this specification, the terms “financial card” 120 and “credit card” 120 are used as exemplary embodiments of a financial instrument 120, but the usage is intended to be construed broadly to encompass any item or device configured to allow a user 110 to access funds.

For example, a plastic card 120 with a magnetic strip 220 is commonly used, with data electronically stored on the magnetic strip 220. In other embodiments, a small keychain fob with RFID technology may be provided and serve a similar function. Other configurations include an RFID chip 220 embedded in a “smart card,” with wireless communication capabilities. In another contemplated embodiment, a plastic card 120 may be provided with electrical pads or leads configured to interface with a USB or similar data slot. Data may be stored on flash or some other similar non-volatile storage medium.

Those having skill in the art will appreciate that there are many other structural variations possible for a financial card 120. The term is intended broadly to encompass any physical token or data structure by which user a 110 may access an account with a financial institution 150.

In the exemplary embodiment, a user 110 has an account with a financial institution 150. The financial institution 150 issues a card 120 to cardholder 110. For example, the financial institution 150 may be a bank, credit union, brokerage, or other similar service provider.

When a user 110 wants to access an account with the financial institution 150, he or she may use the card 120 with a transaction device 130. The transaction device 130 may be operated by a merchant or other entity to which the user 110 wants to transfer money. It may be, for example, a credit card reader 130 or other similar device 130. Transaction device 130 may use a network 140 such as the internet 130 to communicate with the financial institution 150.

The network 140 may be, for example, a LAN, WAN, Wi-Fi, an internetwork of LANs, the Internet, or another communication network providing a data link between the transaction device 130 and the financial institution 150. In some embodiments, the network 140 will include security protocols, such as transport layer security (TLS) or other encryption technology.

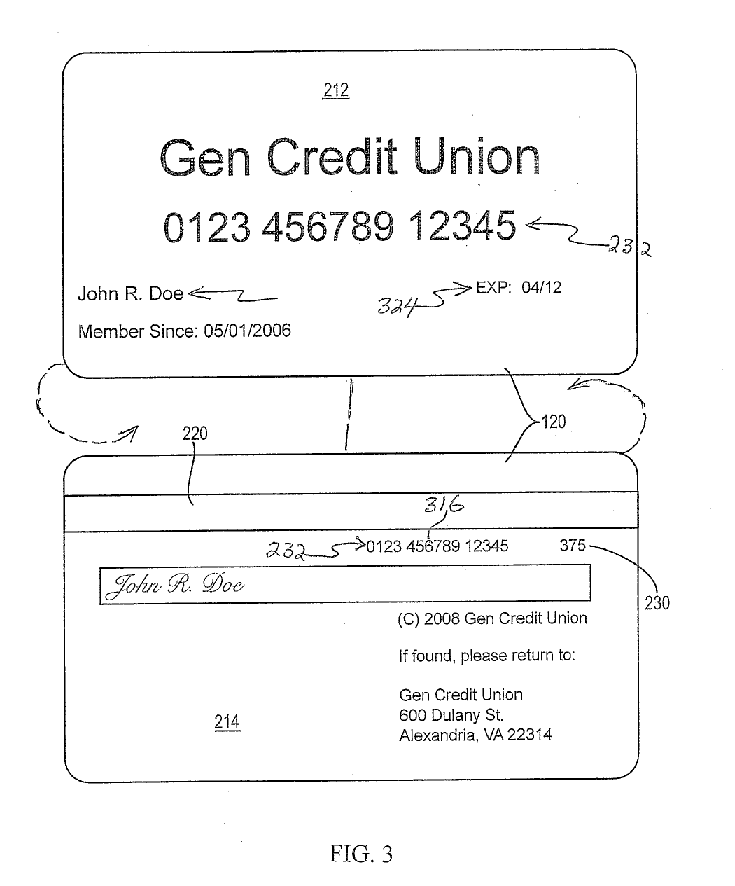

FIG. 3 illustrates an exemplary embodiment of a financial card 120. The exemplary financial card 120 has a front side 212 or face 212 and a reverse side 214 or back 214. On the exemplary front side 212 is useful information such as a financial institution name 240, a card number 270, an expiration date 260, and a user's 110 name 250. On the reverse side 214 there may be additional information, such as a CVV 230 and a signature 280 of the user 110. Those having skill in the art will recognize that each of these items is optional, and the arrangement may be varied without affecting the function of the card 120.

Also on reverse side 214 is a magnetic strip 220. The magnetic strip 220, or its functional equivalent, is the most useful feature of the card. It is common for a magnetic strip 220 to be rewritable. The magnetic strip 220 is a commonly-used exemplary data storage medium. In other embodiments, other data storage media may be used such as optical, holographic, or the like. For example, some credit cards are now equipped with RFID chips, or other electronic storage media. Furthermore, in some cases, devices such as RFID equipped key fobs or even biometric indicators may take the place of the card 120.

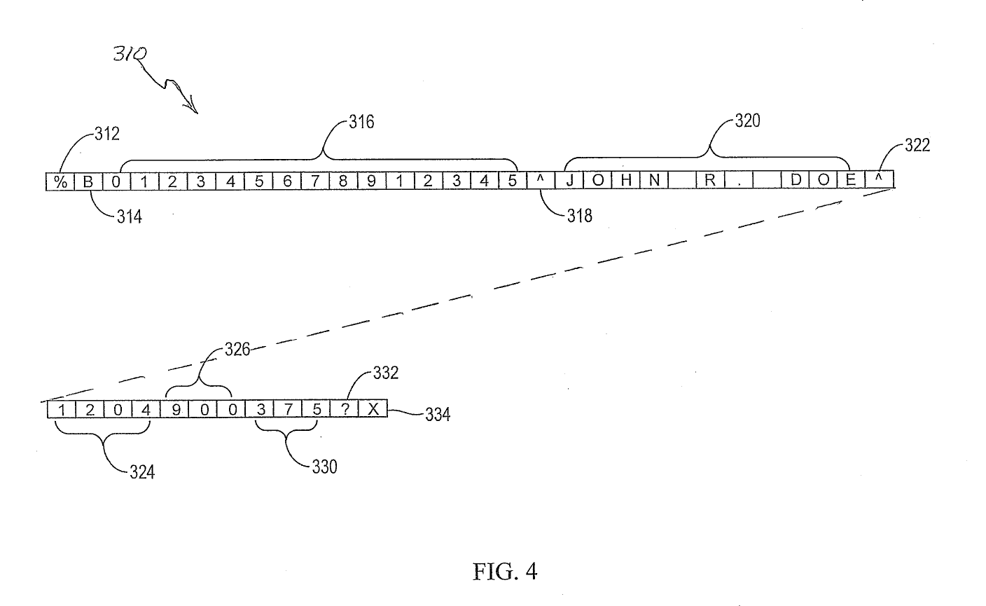

FIG. 4 is a diagrammatic view of a card data structure that may be encoded on the magnetic strip 220 of financial card 210. In this exemplary embodiment, the magnetic strip 220 is divided into up to three tracks, known respectively as track 1, track 2, and track 3. In common usage, both track 1 and track 2 will include the minimum information needed to process the card. The data structure of FIG. 4 discloses exemplary track 1 data. Track 1 is provided as an exemplary embodiment of a card data structure, but those having skill in the art will recognize that the possibilities for card data structures are infinite.

According to this embodiment, track 1 begins with a start sentinel 312, which in the exemplary embodiment is a “%” character. Next is a one character format code 314. Next is a primary account number 316, which may be up to 19 characters long. Next is a field separator 318, which in the exemplary embodiment is a “̂” character. Next is the cardholder name 320, which may be up to 26 characters. Next is another field separator 322, followed by a four digit expiration date 324. Next is a three digit service code 326. The last substantive filled is discretionary field 330, followed by end sentinel 332, which in the exemplary embodiment is a “?” character. Finally a one character longitudinal redundancy check (LRC) 334, is computed according to any suitable methods known in the computer and software art.

In the exemplary embodiment, the discretionary field 330 is encoded with the dynamic CVV 330. For increased security and reliability, other fields of the card data structure may be write protected. Thus, the dynamic CVV 330 contained in the discretionary field 330 is the only re-writable portion of the card data strip 220.

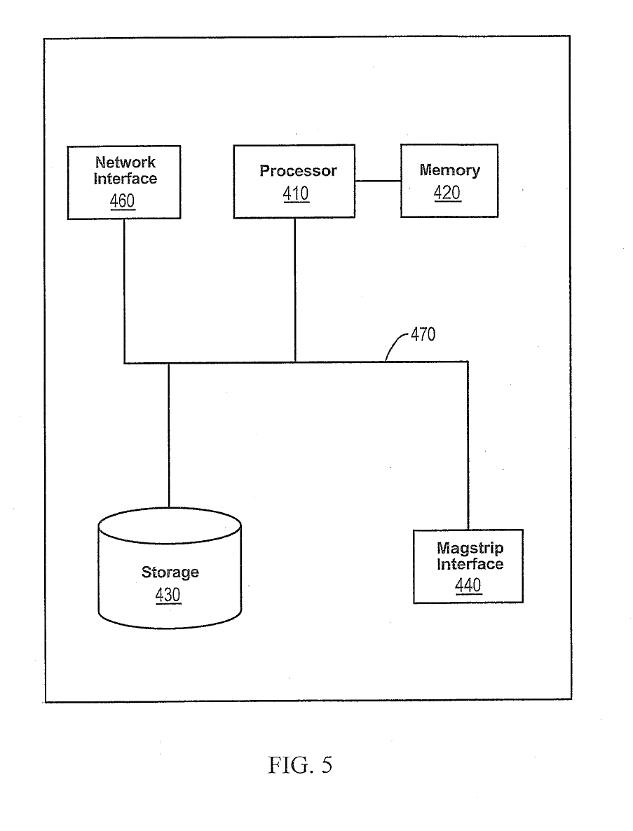

FIG. 5 is a block diagram of an exemplary embodiment of a transaction device 130. The transaction device 130 may be a credit card reader 130, debit card reader 130, ATM 130, or other computer system 130 equipped with an appropriate interface for reading from and writing to a magnetic strip 220. The transaction device 130 is controlled by a processor 410. A processor 410 may be a microprocessor 410, microcontroller 410, or any other similar programmable logic device 410 configured to control the transaction device 130.

A processor 410 may be communicatively coupled to other system components via bus 470. The processor 410 may have connected thereto a memory device 420. In some embodiments, the memory device 420 may be connected to a processor 410 via the bus 470. In other embodiments, the processor 410 may be directly connected to the memory device 420 for direct memory access. Memory 420 may be low-latency, random-access memory (RAM) or other similar low-latency main memory 420.

The processor 410 is also connected to a network interface 460 such as a NIC card. The network interface 460 provides communication with the network 140. The processor 410 may also be connected to a computer-readable storage medium 430. In some embodiments, storage 430 may be a nonvolatile storage medium 430. It and may be a memory device 430 based on technology with higher capacity but also higher latency than the memory 420. Storage 430 may be a hard disk 430, flash disk 430, or other suitable nonvolatile storage medium 430. In some embodiments, the functions of the storage 430 and the memory 420 may be combined in a single memory device.

The processor 410 is also communicatively coupled to a magstrip interface 440. The magstrip interface 440 is configured to allow the processor 410 to read a magnetic strip 220, and also to rewrite magnetic data on the magnetic strip.

The magstrip interface 440 is provided as an exemplary embodiment of a financial card interface. In other embodiments, other technologies may be used. For example, an RFID interface may be used to communicate with “smart cards” equipped with RFID technology. In another exemplary embodiment, the financial card 120 is equipped with electrical leads for providing a USB or other similar data interface. The card 120 may be provided with flash or other non-volatile memory for storing the card data.

Because the transaction device 130 is required to both read from and write to the magnetic strip 220 of the card 120, prior art card readers in which a card is “swiped” may be cumbersome. To facilitate the write operation, the card 120 may have to be swiped twice. For increased simplicity, it may be preferable to instead use a transaction device 130 where the card 120 is fully or partially inserted, so that the magnetic strip can be both read and written as necessary. In other embodiments, wireless communication technology like RFID completely obviates the need for a physical interface between card 120 and transaction device 130.

In an exemplary method of the present disclosure, a user 110 holds the card 120, and desires to purchase goods or services from a merchant operating the transaction device 130. To pay for the goods or services, the user 110 interacts with the transaction device 130. For example, this may be done by inserting the card 120 into a magnetic card reader 130 or placing an RFID-equipped card near transaction device 130.

The transaction device 130 reads the card data structure 310 from the card 120, and transmits verification data, including the dynamic CVV 330, across the network 140 to the financial institution 150.

The financial institution 150 then authenticates the verification data, including the dynamic CVV 330, and transmits a verification code, including a new dynamic CVV 330 to the transaction device 130.

The transaction device 130 reads the new dynamic CVV 330, and writes the new CVV 330 to the magnetic strip 220. The transaction device 130 may then read the dynamic CVV 330 back from the magnetic strip 220 to verify that the updated CVV 330 has been properly written to magnetic strip 220.

Finally, the transaction device 130 may transmit a success code to the financial institution 150 via the network 140. The success code informs the financial institution 150 that the card 120 has been successfully updated with the new dynamic CVV 230. This ensures that the card 120 is ready for its next use.

The financial institution 150 may then update its database to expire the previous dynamic CVV 330, and enter the new dynamic CVV 330 as the valid dynamic CVV 330. To ensure that the card 120 is updated with the new dynamic CVV 330, a financial institution 150 may choose not to provide a final authorization code for the transaction until the success code is received.

Thus, if a card 120 is not successfully updated with the new CVV 330, the old CVV 330 may remain valid. However, the attempted transaction still fails. This prevents a malicious actor from successfully completing several transactions by transmitting the old dynamic CVV 330 and then declining to transmit the success code. For additional security, but at the cost of some amount of lost convenience, a failure to receive the success code may instead result in flagging the account as having encountered a problem. This results in the system treating the card as invalid until the problem is resolved.

Referring to FIGS. 1-4, the present device and method in accordance with the invention for enhanced credit security and card security. In certain embodiments, a dynamic CVV 230 may be used in lieu of or in addition to the static CVV 330 printed on the card 120, and may help to prevent credit card fraud. In one exemplary embodiment, a credit card 120 is provided with a magnetic strip 220, which can be both read and written by a transaction device 130. The transaction device 130 may be, for example, a credit card reader, automated teller machine (ATM), or other similar device.

The transaction device 130 is configured to read a data track, which may include a CVV 330 or other additional dedicated code, from the magnetic strip. They transaction device transmits some or all of the information to a financial institution with which the user has an account. The financial institution receives the account data, and may respond by authorizing the transaction. It may also provide a new CVV 330 to the transaction device. The transaction device 130 may then replace the CVV 330 on the data track with the new CVV 330. Once the new CVV 330 has been provided, the old CVV 330 expires and is no longer valid.

If a malicious actor reads and stores the data from the magnetic strip 220, including the CVV 230 in the discretionary field 330 (the dynamic CVV 330, the malicious actor's ability to cause harm to the user will be reduced, because the dynamic CVV 230 will be valid only once. If the authorized user 110 uses the card 120 before the malicious actor attempts to use the information, the dynamic CVV 330 that the malicious actor reads will have expired, and the transaction will be rejected.

On the other hand, if the malicious actor is able to use the data before the user 110 completes another transaction with the card 120, the user's attempt to use the card will be rejected, as the user's own card 120 will now have an expired CVV 330. This will alert the user that there is a problem with the card 120 and motivate him or her to contact the financial institution 150 to resolve the issue.

The financial institution 150 may also limit its own damage by immediately closing off access to the account once any expired CVV 330 is presented to be used.

Furthermore, even if the malicious user is using a properly-configured transaction device 130 that will receive and store a new dynamic CVV 330 with each fraudulent transaction, malicious activity will be severely limited, because each transaction will need to be sent from the unauthorized device. The malicious user would also need to have an existing account with a credit card clearing house, so that identifying, tracking, and finding the malicious user is greatly simplified.

Because the use of a dynamic CVV 330 may limit the malicious actor to a single unauthorized transaction, investigation of credit card fraud will be greatly simplified. Furthermore, financial harm to both the user 110 and the financial institution 150 will be limited.

In some embodiments, a dynamic CVV 330 may completely replace the static CVV 230, which in the prior art is printed on the card. One purpose of printing the static CVV 230 on the card is so that the CVV 230 can be used to verify purchases where card data are entered manually.

For example, if the user 110 is shopping online, he or she may not have a transaction device 130 available. Instead, manually typing in credit card data may be required to complete the transaction. In one embodiment, a static CVV 230 is printed on the card and it is retained as perpetually valid only for purchases where card data are input manually. It may also be used as a seed or as a cryptographic key coordinated with the dynamic CVV 330. Transactions from a transaction device are required to use the dynamic CVV encoded on the magnetic strip. This configuration may represent an acceptable compromise between security and ease-of-use.

Many malicious actors (e.g., thieves, unauthorized users, etc.) acquire credit card data by using unauthorized card readers. For example, a retail sales clerk may receive a user's credit card, and surreptitiously swipe the card twice-once on an authorized card reader, and once on an unauthorized card reader. Alternatively, “dummy” ATM interfaces may be installed over valid ATMs 130, so that a card's data is read by the unauthorized reader as well as the valid ATM reader 130. Such methods permit malicious actors to unobtrusively mine customers' credit card numbers. With the use of a dynamic CVV 330, this operation becomes less practical. The malicious actor would have to manually write down the static CVV 230 for each card, and also have a way of consistently correlating handwritten CVVs 230 with individual cards. In this exemplary embodiment, the static CVV 230 is never encoded on the magnetic strip 220, so there is no way for the malicious actor to automatically and reliably mine static CVV's 230.

In another exemplary embodiment, security can be further enhanced by not providing a static CVV 230 on the card 120 at all. For example, when the card 120 is provided to the user, it may be provided without any static CVV 230 printed thereon. Instead, the user 110 may be separately informed of a static CVV 230 that can be used for manual input. The user may memorize the static CVV 230, similar to memorizing a pin for a debit card 120, or the user may be provided with a printed reminder of the static CVV 230. For example, a plain paper card 120 may be provided along with the traditional credit card. The use of a plain paper card, which is immediately visually and physically different from a traditional credit card 120 will help to prevent confusion between the card with the static CVV, and the traditional credit card 120 with the dynamic CVV 330. The paper card may have printed thereon the account number, expiration date, and static CVV. The user can use the plain paper card for online purchases or other manual entry purposes.

For enhanced security, the credit card number provided with the plain paper card, including the static CVV, may be a separate number from the number provided on the traditional credit card. In other embodiments, the CVV 230 may be a dummy never to be used. Its use constitutes an alert that the use of the card 120 is improper.

As an additional service, the financial institution 150 may separately track purchases made with the static CVV 230, and those made with the dynamic CVV 330. For yet additional security, the plain paper card with a static CVV 230 may be provided without additional identifying information, such as the user's name. This will help to prevent fraud if the plain paper card is lost. For example, if verification requires providing a name, as it appears on the card, in addition to the card number 316, expiration date 324, and CVV 230, a malicious actor who finds a lost plain paper card will not have the necessary data available for use.

Additional security features may also be provided to supplement use of the dynamic CVV 330. For example, because it is normally expected that a static CVV 230 will be used less frequently than a dynamic CVV 330, the financial institution may required each static CVV 230 transaction to be independently verified, such as by email or text message to an address or phone number on file.

For greater convenience, the user 110 may be allowed to pre-authorize a static CVV 230 transaction. For example, if a user knows he is planning to buy some online products, and that he will be spending $100 or less, he may pre-authorize a static CVV 230 transaction by sending an e-mail or text message, or logging in to a web interface. The user may have the option to set a maximum value for the pre-authorization, such as $100 in this case, and may set an expiration time, such as one hour.

Another supplementary security feature may be based on location. For example, because a dynamic CVV 330 can be valid for only one physical card, a transaction may be flagged as suspicious or invalid if the dynamic CVV 330 is used within a short time at two geographically distant points.

In one example, a user located in Oklahoma may have his card data compromised in New York. When the user returns home to Oklahoma, two transactions may be attempted in a very short time, one from Oklahoma, the other from New York. One of these transactions will have an invalid CVV 330 and will fail anyway. But the presence of these two transactions may cause the account to be flagged, requiring the user 110 to contact the financial institution 150 before any more transactions are authorized.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A method of verification comprising:
providing a financial card comprising a computer readable storage medium embedded therein;
providing a dynamic portion of the computer readable storage medium as a computer writable medium;
designating the dynamic portion as the storage location of a dynamic code to be selectively read from and written to the computer readable storage medium;
receiving, by an issuer computer corresponding to an issuer of the financial card, transaction information from a first transaction in which the information from the financial card is presented as a form of payment;
receiving, by the issuer computer, a first value of the dynamic code stored in the dynamic portion;
verifying, by the issuer computer, the authenticity of the first transaction based at least in part on the receiving the first value;
deleting, by the issuer computer, the first value after the verifying; and
writing, by the issuer computer, a second value of the dynamic code to the dynamic portion.

2. The method of claim 1, wherein the financial card is selected from a credit card, a debit card, a gift card, and a purchase order.

3. The method of claim 1, further comprising:
receiving, by the issuer computer, data representing presentation of the financial card to a second merchant in a second transaction subsequent to the first transaction; and
verifying and authorizing, by the issuer computer, completion of the second transaction.

4. The method of claim 1, further comprising:
receiving, by the financial card, during a second transaction, a third value for the dynamic code replacing the second value.

5. The method of claim 1, wherein:
the first transaction is completed by the financial card with a first merchant;
a second transaction is completed by the financial card with a second merchant; and
the financial institution is independent from the first and second merchants.

6. The method of claim 1, wherein the computer readable storage medium is non-volatile memory.

7. The method of claim 6, wherein the non-volatile memory is selected from magnetic media, optical media, flash media, and another solid state medium.

8. The method of claim 1, further comprising:
receiving by the issuer computer, values of the dynamic code from a plurality of transactions corresponding to an authorized user of the financial card;
changing, by the issuer computer, the values of the dynamic code in accordance with a security scheme expiring the values based on instructions from the issuer computer; and
receiving, by the issuer computer, an expired value of the dynamic code, representing a an unauthorized transaction by an unauthorized user;
failing, by the financial card, a request for verification of the unauthorized transaction, based on the expired value.

9. The method of claim 1, further comprising:
providing a credit transaction system comprising
the financial card;
a transaction device;
a first computer associated with a financial institution operating as an issuer of the financial card;
the first computer programmed to verify the authenticity of transactions based on the transaction device reading the dynamic code and reporting to the first computer based on the dynamic code;
the first computer, further programmed to send to the transaction device values to assign to the dynamic code; and
the transaction device configured to read and write to the financial card the dynamic code.

10. The method of claim 9, wherein the credit transaction system further comprises:
a second computer corresponding to a merchant;
the second computer operably connected to communicate with the first computer;
the second computer programmed to read from the financial card and provide to the second computer a first value corresponding to the dynamic code, the first value being read by the second computer from the financial card during a transaction;
the second computer, further programmed to receive from the first computer a second value corresponding to the dynamic code; and
the second computer, further programmed to overwrite the first value on the financial card with the second value during the transaction.

11. A method of financial certification comprising:
selecting a financial card comprising a computer readable storage medium embedded therein;
the selecting, wherein a dynamic portion of the computer readable storage medium is also a computer writable medium;
the selecting, wherein the dynamic portion is the storage location of a dynamic code to be selectively read from and written to the computer readable storage medium;
presenting to a merchant computer in communication with an issuer computer, the merchant computer corresponding to a merchant in a transaction with the financial card and the issuer computer corresponding to an issuer of the financial card, first transaction information corresponding to a first transaction in which the information from the financial card is presented as a form of payment;
delivering, by the financial card to the issuer computer, a first dynamic code from the dynamic portion;
receiving verification from the issuer computer of the authenticity of the first transaction based at least in part on the delivering the first dynamic code; and
receiving, by the financial card, from the issuer computer, a second dynamic code replacing the first dynamic code from the dynamic portion.

12. The method of claim 11, further comprising:
presenting the financial card to a second merchant in a second transaction subsequent to the first transaction; and
completing successfully the second transaction.

13. The method of claim 12, further comprising:
receiving, by the financial card, during the second transaction, a third dynamic code replacing the second dynamic code.

14. The method of claim 13, wherein the issuer is a financial institution independent from the first and second merchants.

15. The method of claim 14, wherein the financial card is selected from a credit card, a debit card, a gift card, and a purchase order.

16. The method of claim 15, wherein the computer readable storage medium is non-volatile memory.

17. The method of claim 16, wherein the non-volatile memory is selected from magnetic media, optical media, flash media, and another solid state medium.

18. The method of claim 17, further comprising:
presenting, by an unauthorized user, the financial card to a third merchant in association with a third transaction;
presenting to the issuer computer, by the financial card, the third dynamic code;
failing, by the financial card, a verification by the issuer computer during the third transaction, based on an expiration of the third dynamic code.

19. A credit transaction system comprising:
a financial card;
a transaction device;
a first computer associated with a financial institution operating as an issuer of the financial card;
the financial card, further provided with a computer readable storage medium storing a dynamic code;
the first computer programmed to verify the authenticity of a transaction based on the transaction device reading the dynamic code and reporting to the first computer based on the dynamic code;
the first computer, further programmed to send to the transaction device values to assign to the dynamic code; and
the transaction device configured to read and write to the financial card the dynamic code.

20. The credit transaction system further comprising:
a second computer corresponding to a merchant;
the second computer operably connected to communicate with the first computer;
the second computer programmed to read from the financial card and provide to the second computer a first value corresponding to the dynamic code, the first value being read by the second computer from the financial card during a transaction;
the second computer, further programmed to receive from the first computer a second value corresponding to the dynamic code; and
the second computer, further programmed to overwrite the first value on the financial card with the second value during the transaction.
